(19) United States
(12) Patent Application Publication
(10) Pub. No.: US 2008/0006745 A1
(43) Pub. Date: Jan. 10, 2008

(54) Hand-held electronic instrument with stand

(76) Inventors: Seng Chuen Chong, Penang (MY); Soo Keat Lim, Penang (MY); Carol Geok Chooi Leh, Penang (MY); Hui Chun Liao, Taipei (TW)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/481,189

(22) Filed: Jul. 5, 2006

(51) Int. Cl. F16M 11/38

(52) U.S. Cl. 248/166

(57) ABSTRACT

An electronic instrument includes a stand having a first rigid leg portion pivotally attached to a housing via a first hinge. The stand further comprises a second rigid leg pivotally attached to the first rigid leg portion via a second hinge. A first pivot control mechanism secures the stand in a closed position. A second pivot control mechanism secures the stand in a first open position. A third pivot control mechanism holds the first rigid leg portion at a bent angle relative to the second rigid leg portion to secure the stand in a second open position. A fourth pivot control mechanism secures the stand in a third open position. The stand further comprises a section for hanging the electronic instrument when the stand is in the third open position.

### FIELD OF THE INVENTION

The invention relates to the field of support stands for electronic instruments.

### BACKGROUND OF THE INVENTION

U.S. Pat. No. 4,940,204 to Nelson et al. describes a stand for an instrument that is made of a material which is flexible, non-brittle and has substantially no mechanical memory. The stand retains the shape into which it is manually configured by the user. This is beneficial because it allows a variety of viewing angles to a user.

However, this design has several disadvantages. The stand is made from a pair of lengths of wire made from fully annealed cartridge brass. With frequent use such material can fail.

Another disadvantage is that it is difficult to return the stand to a specific desired angle.

Additionally, it is very difficult to precisely adjust the stand to a particular angle using only one hand. The ability to use only one hand can be very useful when performing electrical measurements with a measurement instrument, because the user will often need the other hand to hold a probe or a ladder or for other purposes.

It would be beneficial to have a stand for a hand-held electronic instrument which would be durable over a long product lifetime, which would have discrete viewing angles, and which would be easily adjustable to the discrete viewing angles using only one hand.

### SUMMARY OF THE INVENTION

The present invention provides a stand for a hand-held electronic instrument which is durable over a long product lifetime, has discrete viewing angles, and which is easily adjustable to the discrete viewing angles using only one hand.

More particularly, the present invention provides an electronic instrument comprising a stand having a first rigid leg portion pivotally attached to a housing via a first hinge. The stand further comprises a second rigid leg pivotally attached to the first rigid leg portion via a second hinge. A first pivot control mechanism secures the stand in a closed position. A second pivot control mechanism secures the stand in a first open position. A third pivot control mechanism holds the first rigid leg portion at a bent angle relative to the second rigid leg portion to secure the stand in a second open position. A fourth pivot control mechanism secures the stand in a third open position. The stand further comprises a section for hanging the electronic instrument when the stand is in the third open position. A fifth pivot control mechanism secures the second rigid leg portion in substantially a coplanar position relative to the first rigid leg portion so that the stand is in a substantially straight-configuration.

The invention further comprises a method of adjusting the viewing angle of the electronic instrument.

### BRIEF DESCRIPTION OF THE DRAWINGS

FIG. 1 shows a hand-held multimeter supported by a multimeter stand.

FIG. 2 is a diagrammatic illustration of four discrete and distinct positions of the stand.

FIG. 3 is a perspective view of a first rigid leg portion of the stand.

FIG. 4 is a perspective view of a second rigid leg portion of the stand.

FIG. 5 is a front perspective-view of the stand in a pivoted position.

FIG. 6 is a rear elevational-view of the stand in the pivoted position.

FIG. 7 is a close-up side elevational-view of the stand with the second hinge forming a pivot connection between the first and second rigid leg portions.

FIG. 8 is a bottom plan-view of the stand in the straight-configuration.

FIG. 9 is a top perspective-view of the stand in the straight-configuration.

FIG. 10 is a close-up view of a housing socket of a housing.

FIG. 11 shows a close-up cutaway view of the first rigid leg portion pivotally attached to the housing via the first hinge.

FIG. 12 is a bottom plan-view of the back of the hand-held multimeter with the stand attached and in a closed position.

FIG. 13 is a close-up view of the first hinge attaching the stand to the housing.

FIG. 14 is a side elevational-view showing a first open position of the multimeter.

FIG. 15 shows a close-up view of the first hinge when the stand is in the first open position.

FIG. 16 is a side elevational-view showing the second open position of FIG. 2 in more detail.

FIG. 17 is a side elevational-view showing the third open position of FIG. 2 in more detail.

FIGS. 18 and 19 are perspective views showing the stand held in the third open position by a fourth pivot control mechanism comprising a hump and a mating-surface crossbar.

FIG. 20 shows a hanging position where the multimeter is hanging from a nail extending from a vertical surface of a wall and passing through the hole.

FIG. 21 is a flowchart illustrating a method of using the present invention.

### DETAILED DESCRIPTION

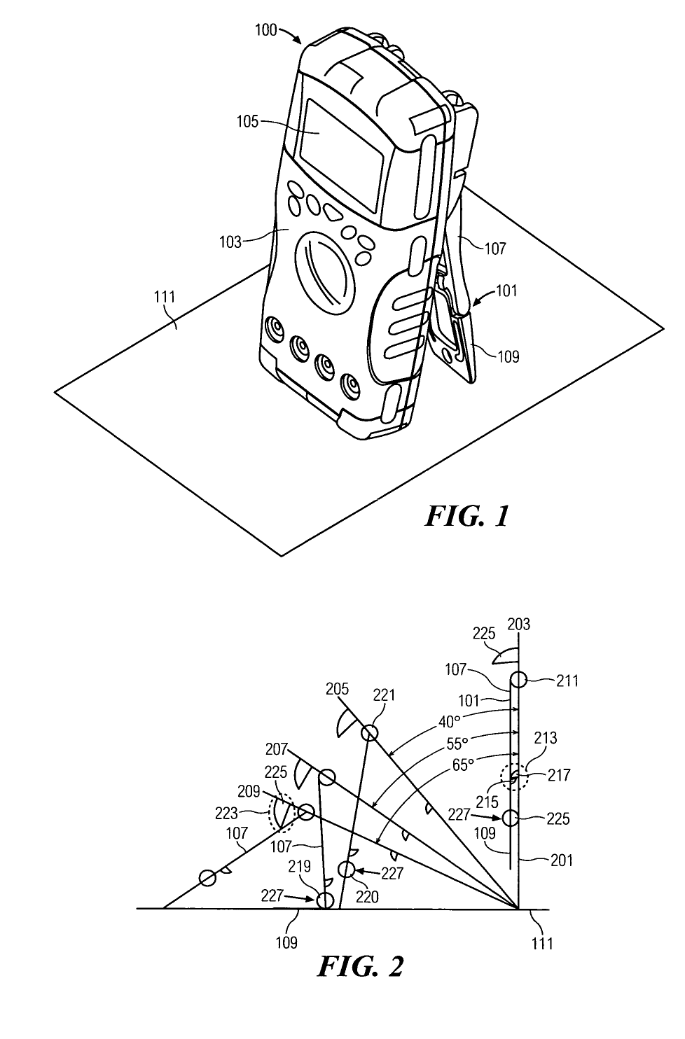

FIG. 1 shows a hand-held multimeter 100 supported by a multimeter stand 101. The multimeter 100 is enclosed in a housing 103 and includes an LCD 105 for displaying information to a user. The LCD 105 is a flat panel. The multimeter 100 and stand 101 are shown resting on a horizontal surface 111 which might be a table top or the surface of a work bench, for example.

The stand 101 comprises a first rigid leg portion 107 pivotally attached to the housing 103. The stand 101 further comprises a second rigid leg portion 109 pivotally attached to the first rigid leg portion 107.

The stand 101 has four discrete and distinct positions as illustrated diagrammatically in FIG. 2. The four positions include a closed position 203, typically used when a user is holding or carrying the multimeter. Also included are three open positions 205, 207, 209 which provide three different viewing angles of the LCD 105 when the multimeter is resting on the surface 111 so that information can be displayed to a user.

It is common for technicians who use hand-held multimeters and other hand-held electronic instruments to suffer back and neck problems attributable to the use of these instruments. The instrument will often be placed on a planar horizontal surface and at the same time the technician must use both hands to take a measurement. However, it is often necessary to have a perpendicular viewing angle of the LCD in order to have a good view of the displayed information. In order get a good view of the LCD while using both hands to take a measurement the technician might have to twist their body into awkward positions for long periods of time. The three viewing angles of the hand-held electronic instrument with stand of the present invention allows the technician to adjust the viewing angle to one suitable for their body position thereby making the workplace more ergonomic.

In FIG. 2, the housing 103 of the multimeter 100 is represented by a plane 201 which is generally parallel to a plane of the front-face surface of the LCD 105. The stand 101 is pivotally connected to the multimeter 201 by a first hinge 211 and in the three open positions supports the multimeter 100 on the surface 111.

In the closed position 203 the stand 101 lays along the housing 103, approximately parallel to the plane 201. A first pivot control mechanism 213 is comprised of a closed position notch 217 of the plane 201 or multimeter 100 and a closed position securing tab 215 of the second rigid leg portion 109. The stand closed position securing tab 215 is snapped into the closed position notch 217 to secure the stand 101.

The three open positions 205, 207, 209 can be defined by the viewing angle of the plane of the LCD 105, or equivalently the viewing angle of the plane 201 which is parallel to the plane of the LCD 105. The viewing angle is the angle of the plane of the LCD 105, or the plane 201, relative to a line perpendicular to the surface 111. It is also equivalently the angle of the line-of-sight of a user relative to the surface 111 when the user views the LCD 105 at an angle perpendicular to the plane of the LCD 105.

In the first open position 205, the first rigid leg portion 107 and second rigid leg portion 109 are approximately co-planer. In this position the stand 101 can be described as being in its “straight-configuration”. The stand 101 is held in the “straight-configuration” by a fifth pivot control mechanism 220. In the first open position 205 the straight-configuration stand 101 supports the multimeter 100 at a 40-degree viewing angle. A second pivot control mechanism 221 secures the stand relative to the housing in the first open position 205.

The first rigid leg portion 107 is pivotally connected to the second rigid leg portion 109 via a second hinge 227. In the second open position 207, by pivoting the second rigid leg portion 109 to an angle of approximately 90-degrees relative to the first rigid leg portion 107 at the second hinge 227, the stand is adjusted to support the multimeter 100 at a 55-degree viewing angle. In this position the stand 101 can be described as being in its “pivoted-configuration”. A third pivot control mechanism 219 holds the stand in the second open position 207.

In the third open position 209, the first rigid leg portion 107 and second rigid leg portion 109 are again approximately co-planer (the stand 101 is in the straight-configuration) and the stand 101 supports the multimeter 100 at a 65-degree viewing angle. The stand 101 is held in the third open position 209 by a fourth pivot control mechanism 223 which includes a hump 225 which makes contact with a portion of the first rigid leg portion 107 of the stand 101.

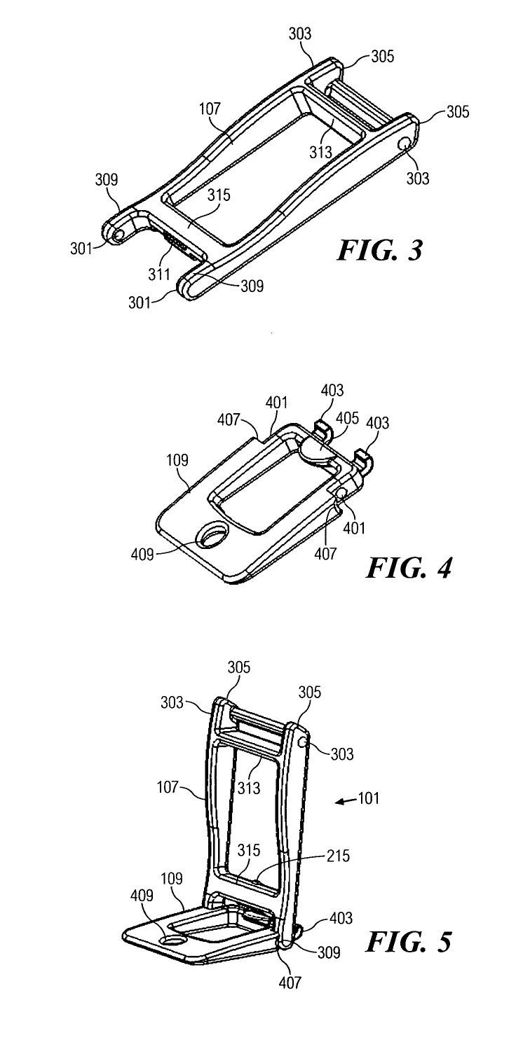

FIG. 3 shows the first rigid leg portion 107 in more detail. The first rigid leg portion 107 includes pivot sockets 301, pivot knobs 303, first leg to housing pivot-control surfaces 305, first leg to second leg pivoted-configuration locking side surfaces 309, a mating-surface crossbar 313 and a stand straight-configuration locking ridge 311 on a stand locking crossbar 315.

FIG. 4 shows the second rigid leg portion 109 in more detail. The second rigid leg portion 107 includes second rigid leg portion pivot knobs 401, stand straight-configuration pivot control hooks 403, second leg pivot control edges 407 and a hanging hole 409.

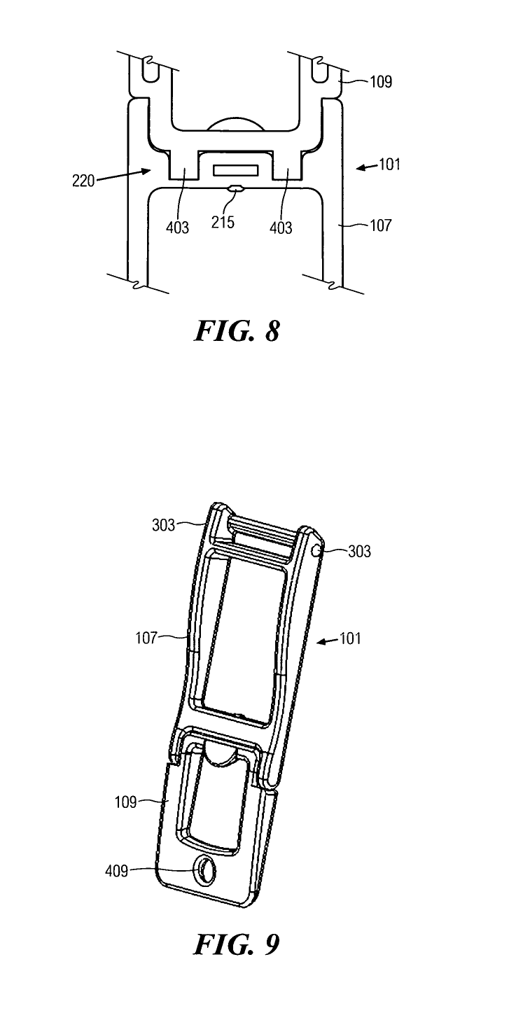

FIGS. 5-9 show the second rigid leg portion 109 pivotally attached to the first rigid leg portion 107 by fitting the pivot knobs 401 into the pivot sockets 301 to form the stand 101. FIGS. 5-7 show the stand in the pivoted-position while FIGS. 8 and 9 show the stand in the straight-configuration.

FIG. 5 shows a front view of the stand 101 in the pivoted position. Also visible is the stand closed position securing tab 215.

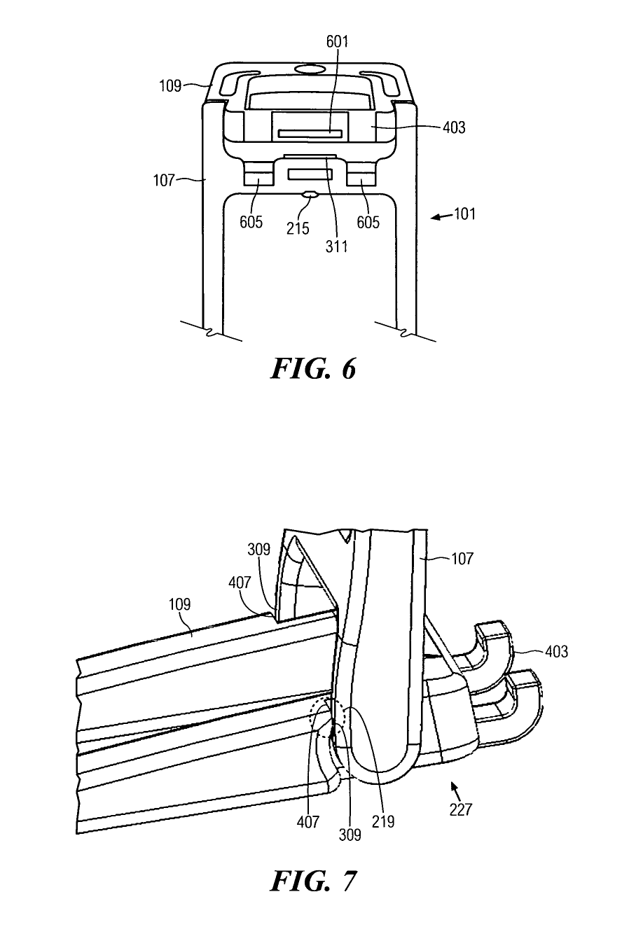

FIG. 6 shows a back view of the stand 101 in the pivoted position. Again visible is the stand closed position securing tab 215 of FIG. 5. FIG. 6 also shows several features of the first rigid leg portion 107 and the second rigid leg portion 109 not visible in FIGS. 3 and 4. Hook apertures 605 of the first rigid leg portion 107 are disposed to receive the pivot control hooks 403 of the second rigid leg portion 109 to secure the stand 101 in the straight-configuration. A stand straight-configuration locking aperture 601 is disposed to receive the stand straight-configuration locking ridge 311, also to secure the stand 101 in the straight-configuration.

FIG. 7 is a close-up view of the second hinge 227 forming a pivot connection between the first and second rigid leg portions 107, 109 of the stand 101. A third pivot control mechanism 219 is comprised of the first leg to second leg pivoted-configuration locking side surfaces 309 and the second leg pivot control edges 407 which contact each other to prevent rotation further than a certain angle, for example 90-degrees to help secure the stand 101 in the second open position 207.

FIG. 8 shows a back view of the stand 101 in the straight-configuration and FIG. 9 shows a front view of the stand 101 in the straight-configuration. Again, it can be seen that in the straight-configuration the first rigid leg portion 107 and second rigid leg portion 109 are approximately co-planer as used in the first open position 205 and the third open position 209. In moving from the pivoted position of FIGS. 5-7 to the straight-configuration of FIGS. 8 and 9, the first rigid leg portion 107 and second rigid leg portion 109 are rotated about an pivot axis of the second hinge 227 formed by the pivot knobs 401 inserted into the pivot sockets 301. The first rigid leg portion 107 and second rigid leg portion 109 are rotated until the stand straight-configuration locking ridge 311 locks into the stand straight-configuration locking aperture 601 and the stand straight-configuration pivot control hooks 403 lock into the hook apertures 605 (all visible in FIG. 6). The fifth pivot control mechanism 220 is comprised of the stand straight-configuration locking ridge 311, stand straight-configuration locking aperture 601, stand straight-configuration pivot control hooks 403 and hook apertures 605.

The stand 101 is comprised of a skeletal frame which has sufficient strength to support the handheld device, while at the same time reducing the overall weight, reducing the material used and thereby reducing the material cost used in the molding process. The weight of the stand 101 is approximately half that of a fully filled stand. The molding time is also less than that of a fully filled stand. Additionally, the parts of the frame design are less prone to shrinkage and warping during the molding process than are those of a fully filled design.

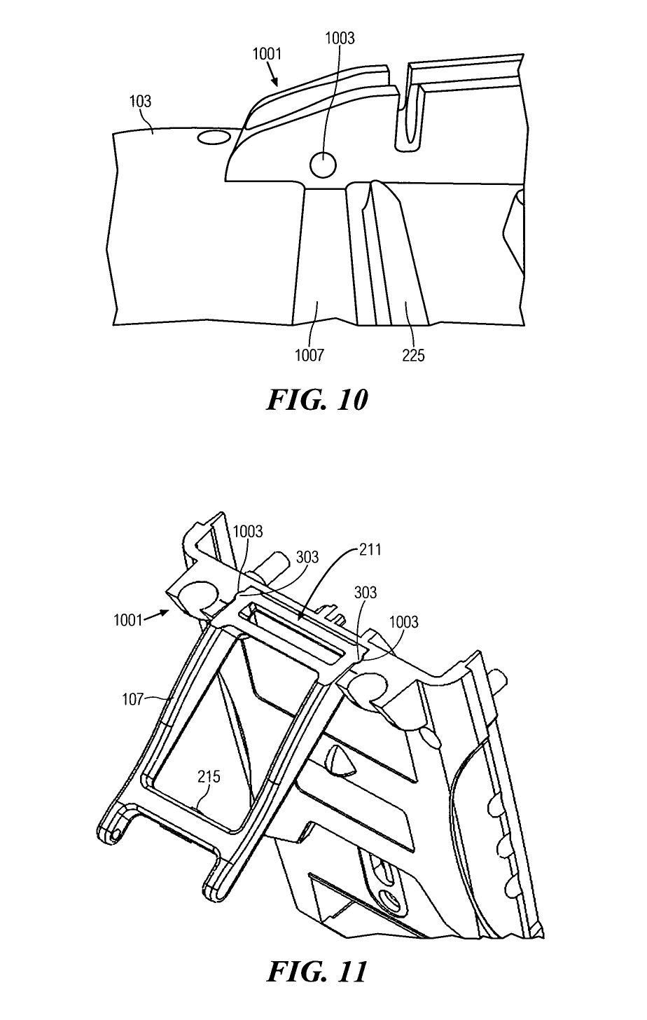

FIG. 10 shows a close-up view of a housing socket 1003 of the housing 103. The housing socket 1003 can be formed in a hinge bracket 1001. The housing socket 1003 is shown without the stand 101 attached for clarity. The first hinge 211 comprises the two housing sockets 1003 (only one is shown in the figure) and the pivot knobs 303 of FIG. 3. The second pivot control mechanism 221 of FIG. 2 includes the trench 1007. The fourth pivot control mechanism 223 of FIG. 2 includes the hump 225. The housing socket 1003 formed in the hinge bracket 1001 is used to pivotally attach the first rigid leg portion 107 to the housing 103.

FIG. 11 shows a close-up cutaway view of the first rigid leg portion 107 pivotally attached to the housing 103 via the first hinge 211. Again, the first hinge 211 is formed from the two pivot knobs 303 pivotally inserted into the two housing sockets 1003 formed in the hinge bracket 1001.

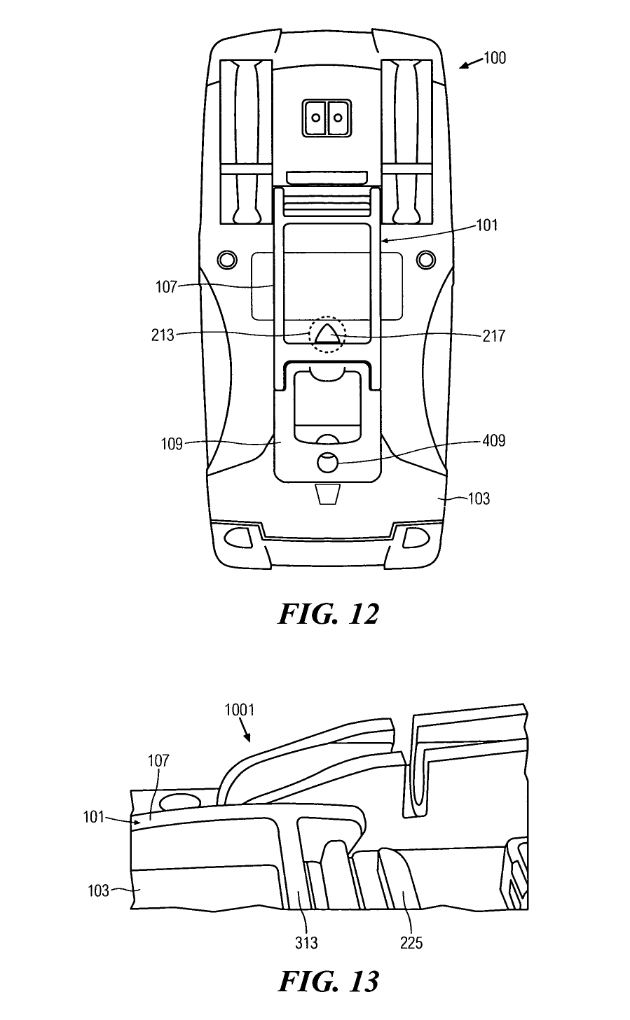

FIG. 12 is a more detailed back view of the hand-held multimeter 100 with the multimeter stand 101 attached and in the closed position 203. In the closed position 203 the stand 101 lays along the housing 103, approximately parallel to the plane 201 of the multimeter as described above with respect to FIG. 2. The first pivot control mechanism 213, comprised of the closed position notch 217 and the closed position securing tab 215 of the second rigid leg portion 109 are shown. The stand closed position securing tab 215 is snapped into the closed position notch 217 to secure the stand 101 in the closed position 203.

FIG. 13 shows a close-up view of the first hinge 211 attaching the multimeter stand 101 to the housing 103. The multimeter stand 101 is shown in the closed position 203 of FIG. 2.

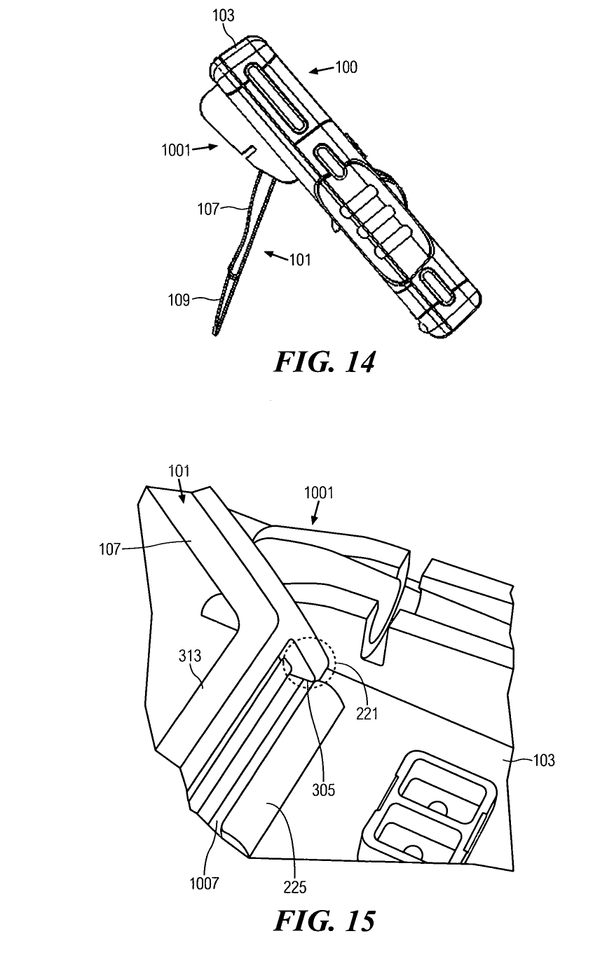

FIG. 14 is a side view showing the first open position 205 of FIG. 2 in more detail. The first rigid leg portion 107 and second rigid leg portion 109 are approximately co-planer in the straight-configuration. In the first open position 205 the straight-configuration stand 101 supports the multimeter 100 at a 40-degree viewing angle.

FIG. 15 shows a close-up view of the first hinge 211 with the multimeter stand 101 in the first open position 205. The second pivot control mechanism 221, comprised of the first leg to housing pivot-control surfaces 305 and the trench 1007, is shown. The first leg to housing pivot-control surfaces 305 rotate into the trench 1007 so that the surfaces 305 and surfaces of the trench 1007 form a frictional connection with each other. The angle of the surfaces 305 and location of the pivot axis (formed by the two pivot knobs 303 and the two housing hinge holes 1003) allows the first rigid leg portion 107 to rotate from its position outside the trench 1007 (as illustrated in FIG. 13) to its frictionally locked position resting in the trench 1007 (as illustrated in FIG. 15).

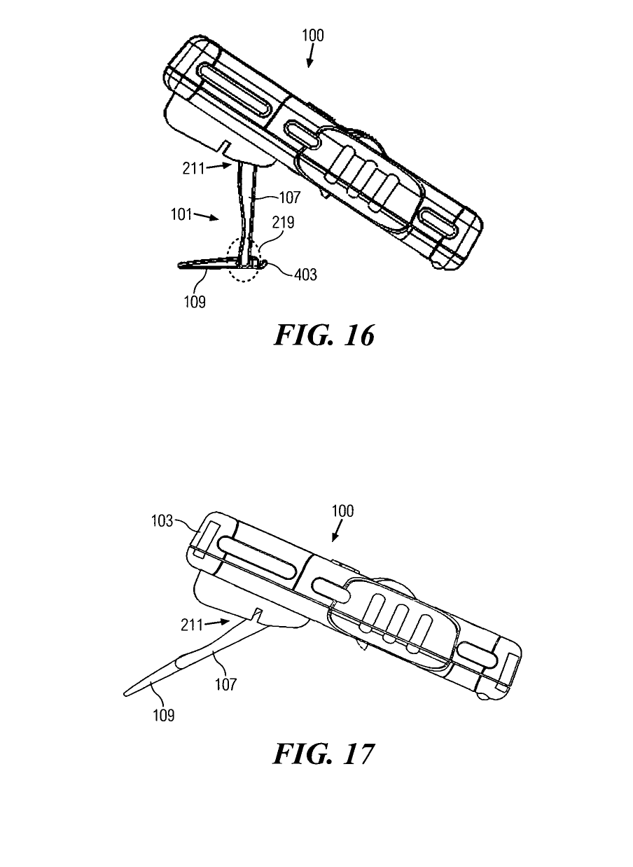

FIG. 16 is a side view showing the second open position 207 of FIG. 2 in more detail. The position of the first rigid leg portion 107 relative to the housing 103 is the same as illustrated in FIG. 14. However, in the second open position the third pivot control mechanism 219 holds the first rigid leg portion 107 at a bent angle relative to the second rigid leg portion 109 as described with respect to FIGS. 5-7 above.

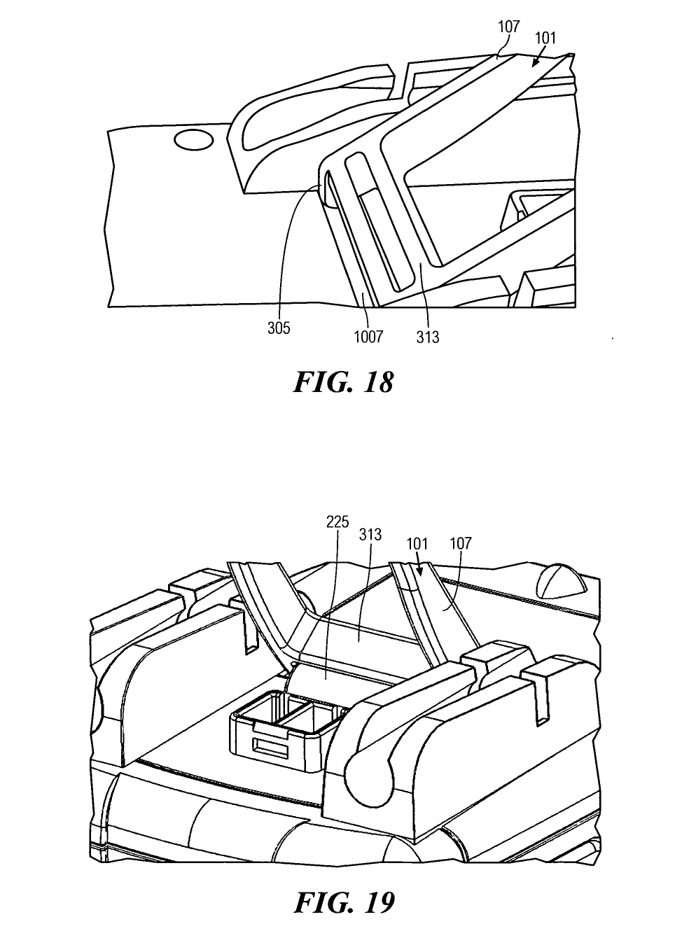

FIG. 17 is a side view showing the third open position 209 in more detail. In the third open position 209 the stand 101 is placed in the straight-configuration which is described in more detail above with respect to the closed position 203 and first open position 205. The position of the first rigid leg portion 107 relative to the housing 103 changes from that shown in FIG. 16 to that shown in FIG. 17. To obtain the third open position 209, the first leg to housing pivot-control surfaces 305 are rotated out of the trench 1007 by applying a force to the stand to overcome the frictional connection between the surfaces 305 and surfaces of the trench 1007. The angle of the surfaces 305 and location of the pivot axis (formed by the two pivot knobs 303 and the two housing hinge holes 1003) allows the first rigid leg portion 107 to rotate from its position within the trench 1007 (as illustrated in FIG. 15) to the position illustrated in FIG. 18.

As shown in FIGS. 18 and 19, the stand 101 is held in the third open position 209 by the fourth pivot control mechanism 223 comprising the hump 225 and the mating-surface crossbar 313. The mating-surface crossbar 313 contacts the hump 225 thereby resisting pivoting about the pivot axis (formed by the two pivot knobs 303 and the two housing hinge holes 1003) after moving to the third open position 209.

As shown in FIG. 19, the stand 101 reaches the maximum open angle of the third open position 209 when the mating-surface crossbar 313 contacts the hump 225.

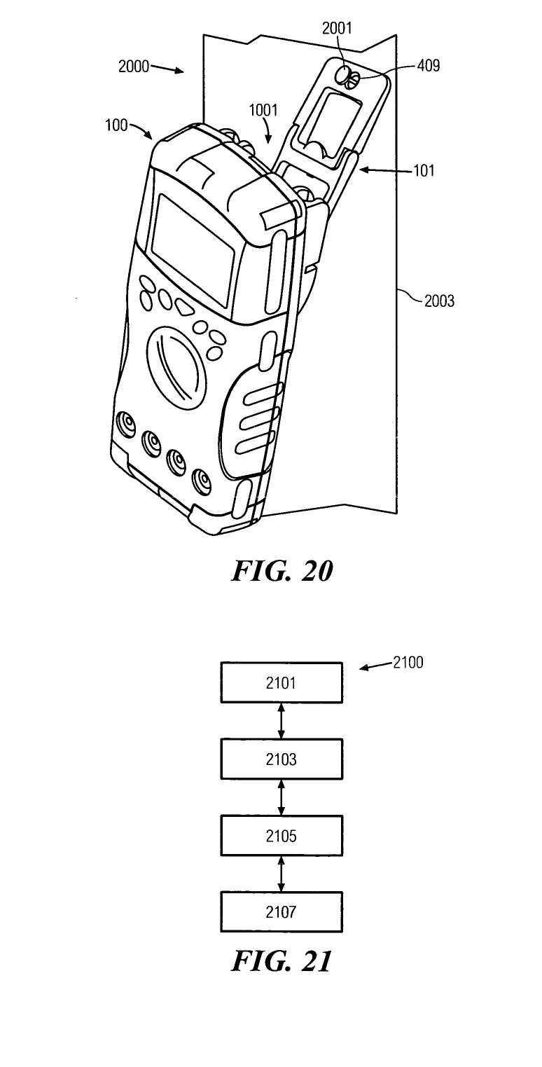

FIG. 20 shows a hanging position 2000 where the multimeter 100 is hanging from a nail 2001 extending from a vertical surface of a wall 2003 and passing through the hole 409. More generally the hole 409 is any type of section for hanging the multimeter and the nail 2001 is any type of hanger used to support the multimeter 100. In the hanging position 2001 the position of the stand 101 is the same as that in the third open position 209. The ergonomic hanging position 2001 is particularly useful for users who are working on locations high above the ground or at locations where there are no horizontal planer supports on which to put the multimeter 100.

The housing 103 and multimeter stand 101 can be made from a ABS+PC thermoplastic alloy, such as “CYCOLOY C2800” from General Electric Plastics, for example.

FIG. 21 shows a method 2100 for adjusting the viewing angle of the multimeter 100 of the present invention. The method comprises the following steps:

2101: moving a stand of the electronic instrument (100) between a closed position (203), in which the stand is secured along a housing (103) of the electronic instrument via a first pivot control mechanism (213), and a first open position (205), in which the stand is secured by a second pivot control mechanism (221), so that a plane of the stand is at an angle of between 20 and 110 degrees relative to a plane of a display panel of the electronic instrument. In a preferred embodiment an angle in the 20 to 110 degree range is used to provide a viewing angle between approximately 25 to 55 degrees and preferably approximately 40 degrees.

2103: moving the stand between the first open position (205) and a second open position (207) in which the stand is secured by a third pivot control mechanism (219), so that a plane of the stand is at an angle of between 20 and 110 degrees relative to a plane of the display panel and the first rigid leg portion is bent at an angle relative to the second rigid leg portion. In this step the first rigid leg portion can bent at an angle of between 80 and 120 degrees relative to the second rigid leg portion. In a preferred embodiment an angle in the above stated 20 to 110 degree range is used to provide a viewing angle of between approximately 40 and 70 degrees and preferably approximately 55 degrees when the first rigid leg portion is bent relative to the second rigid leg portion.

2105: moving the stand between the second open position (207) and a third open position (209) in which the stand is secured by a fourth pivot control mechanism (223), so that a plane of the stand is at an angle of between 70 and 180 degrees relative to a plane of the display panel. In a preferred embodiment an angle in the 70 to 180 degree is used to provide a viewing angle of between approximately 50 and 80 degrees and preferably 65 degrees.

2107: hanging the electronic instrument via a hanging section (409) when the stand is in the third open position.

In the steps 2103 and 2105 of moving the stand between the first open position (205), second open position (207) and third open position (209) additional steps include moving the stand between a substantially straight-configuration, wherein the a fifth pivot control mechanism (220) secures the position of the first rigid leg portion (107) relative to the second rigid leg portion (109) and a configuration wherein a third pivot control mechanism (219) holds the first rigid leg portion (107) at a bent angle relative to the second rigid leg portion (109).

Rather than being used with a multimeter, the present invention can be used with many other types of hand-held electronic instruments.

Also, in the present invention, hand-held is not limited to a device that is actually held in a user's hand. Rather, it is meant to describe a device that is of a size which is generally suitable for being held by or in a hand of a user if desired.

The present invention is not limited to use with a hand-held electronic instrument using a flat panel LCD. Other types of displays can be used in addition to or in substitution of the LCD.

In other embodiments, in the first open position 205, the stand 101 can support the multimeter 100 at a viewing angle between 20 and 110-degrees, in the second open position 207, the stand 101 can support the multimeter 100 at an angle between 30 and 100-degrees, and in the third open position 209, the stand 101 can support the multimeter 100 at an angle between 70 and 180-degrees. In the second open position 207, the first rigid leg portion 107 can be bent at an angle of between 80 and 120 degrees relative to the second rigid leg portion 109.

In yet another embodiment the first, second and third positions can allow any three different viewing angles. Also, the invention can include more than three positions to allow more than three different viewing angles.

In the foregoing specification, the invention has been described with reference to specific exemplary embodiments thereof. The specification and drawings are, accordingly, to be regarded in an illustrative sense rather than a restrictive sense.

1. An electronic instrument comprising:
a housing;
a stand comprising a first rigid leg portion pivotally attached to the housing via a first hinge;
the stand further comprising a second rigid leg portion pivotally attached to the first rigid leg portion via a second hinge;
a first pivot control mechanism for securing the stand in a closed position;
a second pivot control mechanism for securing the stand in a first open position; and
a third pivot control mechanism for holding the first rigid leg portion at a bent angle relative to the second rigid leg portion to secure the stand in a second open position.

2. The electronic instrument of claim 1, further comprising a fourth pivot control mechanism for securing the stand in a third open position.

3. The electronic instrument of claim 2, wherein the stand further comprises a section for hanging the electronic instrument when the stand is in the third open position.

4. The electronic instrument of claim 1, further comprising a fifth pivot control mechanism for securing the second rigid leg portion in substantially a coplanar position relative to the first rigid leg portion so that the stand is in a substantially straight-configuration.

5. The electronic instrument of claim 1, wherein the electronic instrument includes a display panel and wherein in the closed position the stand is positioned to lay generally along the housing substantially parallel to the display panel.

6. The electronic instrument of claim 1, wherein the electronic instrument includes a display panel and wherein in the first open position a plane of the stand is at an angle of between 20 and 110 degrees relative to a plane of the display panel.

7. The electronic instrument of claim 1, wherein the electronic instrument includes a display panel and wherein in the second open position a plane of the stand is at an angle of between 20 and 110 degrees relative to a plane of the display panel and the first rigid leg portion is bent at an angle relative to the second rigid leg portion.

8. The electronic instrument of claim 7, wherein the first rigid leg portion is bent at an angle of between 80 and 120 degrees relative to the second rigid leg portion.

9. The electronic instrument of claim 1, wherein the electronic instrument includes a display panel and wherein in the third open position a plane of the stand is at an angle of between 70 and 180 degrees relative to a plane of the display panel.

10. The electronic instrument of claim 3, wherein the section for hanging the electronic instrument comprises a hole passing through the second rigid leg portion through which a hanger is inserted for supporting the electronic instrument.

11. A method of adjusting the viewing angle of an electronic instrument comprising the steps of:
moving a stand of the electronic instrument between a closed position, in which the stand is secured along a housing of the electronic instrument via a first pivot control mechanism, and a first open position, in which the stand is secured by a second pivot control mechanism, so that a plane of the stand is at an angle of between 20 and 110 degrees relative to a plane of a display panel of the electronic instrument; and
moving the stand between the first open position and a second open position in which the stand is secured by a third pivot control mechanism, so that a plane of the stand is at an angle of between 20 and 110 degrees relative to a plane of the display panel and the first rigid leg portion is bent at an angle relative to the second rigid leg portion.

12. The method of claim 11 wherein the first rigid leg portion is bent at an angle of between 80 and 120 degrees relative to the second rigid leg portion.

13. The method of claim 11, further comprising the step of:
moving the stand between the second open position and a third open position in which the stand is secured by a fourth pivot control mechanism, so that a plane of the stand is at an angle of between 70 and 180 degrees relative to a plane of the display panel.

14. The method of claim 12, further comprising the step of:
hanging the electronic instrument via a hanging section when the stand is in the third open position.

15. The method of claim 13, wherein the steps of moving the stand between the first open position, second open position and third open position further comprise the steps of moving stand between a substantially straight-configuration, wherein the a fifth pivot control mechanism secures the first rigid leg portion in a position relative to the second rigid leg portion, and a configuration wherein a third pivot control mechanism holds the first rigid leg portion at a bent angle relative to the second rigid leg portion.
